(19) United States
(12) Patent Application Publication
(10) Pub. No.: US 2012/0078671 A1
(43) Pub. Date: Mar. 29, 2012

(54) Intelligent Automated Dispatch And Mobile Resources Management System

(75) Inventors: Matthew Mohebbi, Potomac, MD (US); Cosmin Vlad Ditu, Gaithersburg, MD (US); Muhammad Imran Younus Siddiqui, Lahore (PK)

(73) Assignee: IT Curves LLC, Gaithersburg, MD (US)

(21) Appl. No.: 13/247,431

(22) Filed: Sep. 28, 2011

Related U.S. Application Data
(60) Provisional application No. 61/387,764, filed on Sep. 29, 2010.

(51) Int. Cl. G06Q 10/06

(52) U.S. Cl. 705/7.12

(57) ABSTRACT

A method, system, and computer program product for automated operation of a vehicle fleet. A request to dispatch a vehicle to a particular location is automatically received. The location of a vehicle to be dispatched is automatically determined. Instructions are automatically sent to that vehicle to proceed to the particular location.

### CROSS-REFERENCE TO RELATED APPLICATION

This application claims the benefit of the filing date of U.S. Provisional Application No. 61/387,764, filed Sep. 29, 2010, the disclosure of which is incorporated herein by reference as though set forth in full below. This application is also related to concurrently filed U.S. patent application Ser. No. ______, (Attorney Docket 3023.0010002), the disclosure of which is incorporated herein by reference as though set forth in full below.

### BACKGROUND

1. Field

The present disclosure relates to methods and systems for an intelligent automated dispatch and mobile resources management to respond to service requests.

2. Background

On-demand transportation services are common. For example, taxis often wait at designated locations to be called by a dispatcher to pick up a fare. When the dispatcher calls a taxi to schedule a pick up, the dispatcher does not necessarily know the exact location of the taxi or whether that taxi is available to accept a service request. Similarly, police, fire, and emergency medical service vehicles are often required to be available to send to specific locations. Likewise, the dispatcher of such vehicles does not necessarily know which vehicles to dispatch as being in the most convenient location to provide the service. What is needed is a system and method for allocating mobile resources in an efficient and automated manner.

### BRIEF SUMMARY

This disclosure relates to a method and system for automated operation and management of mobile resources. A request to dispatch a mobile resource with certain attributes to a particular location to provide certain services is received through various means such as call centers, web-requests, or mobile phone applications and text messages, etc. The location of a mobile resource to be dispatched is automatically determined via automated locator and wireless communications to the system. The system makes a decision based on best fit attributes, closest or most efficient distance, and time of request vs. time of availability of the mobile resource. Assignments are made and instructions are then automatically sent to that mobile resource to proceed to the particular location to perform the requested services.

Further features and advantages of embodiments described herein, as well as the structure and operation of various embodiments, are described in detail below with reference to the accompanying drawings. It is noted that the embodiments described below are not limited to the specific embodiments described herein. Such embodiments are presented herein for illustrative purposes only. Additional embodiments will be apparent to persons skilled in the relevant art based on the teachings contained herein.

### BRIEF DESCRIPTION OF THE DRAWINGS/FIGURES

Embodiments are described with reference to the accompanying drawings. The accompanying drawings, which are incorporated herein and form a part of the specification, illustrate embodiments and, together with the description, further serve to explain the principles of the embodiments and to enable a person skilled in the relevant art to make and use the embodiments. In the drawings, like reference numbers may indicate identical or functionally similar elements. The drawing in which an element first appears is generally indicated by the left-most digit(s) in the corresponding reference number.

FIG. 1 shows an overall system diagram of an embodiment of the automated dispatch system.

FIG. 2 shows a flow diagram of interactions between a mobile resource operator and the automated dispatch system.

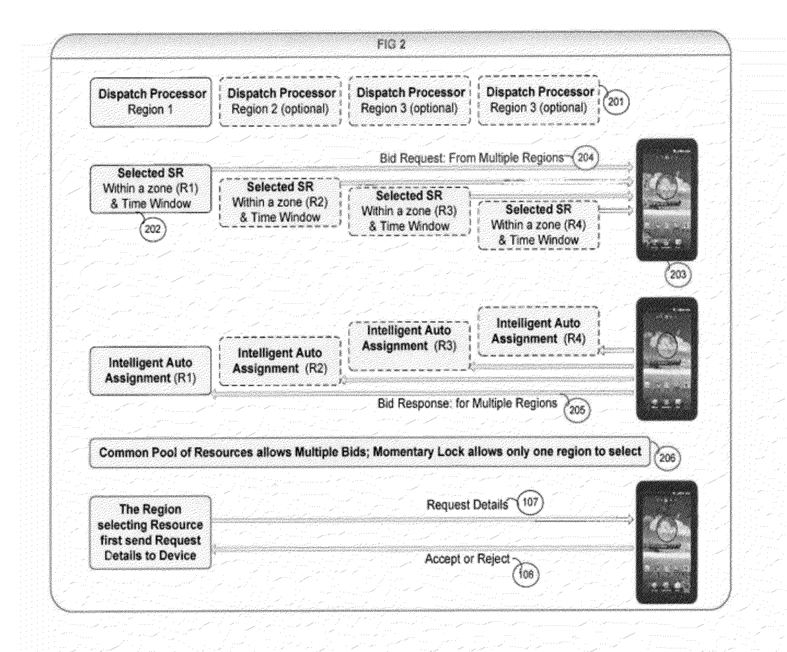

FIG. 3 shows a flow chart of the automated dispatch system for one region illustrating the elements of decision making to assign and dispatch a mobile resource.

FIG. 4 is a screen shot of a mobile resource pool showing the list and location of mobile resources on the map.

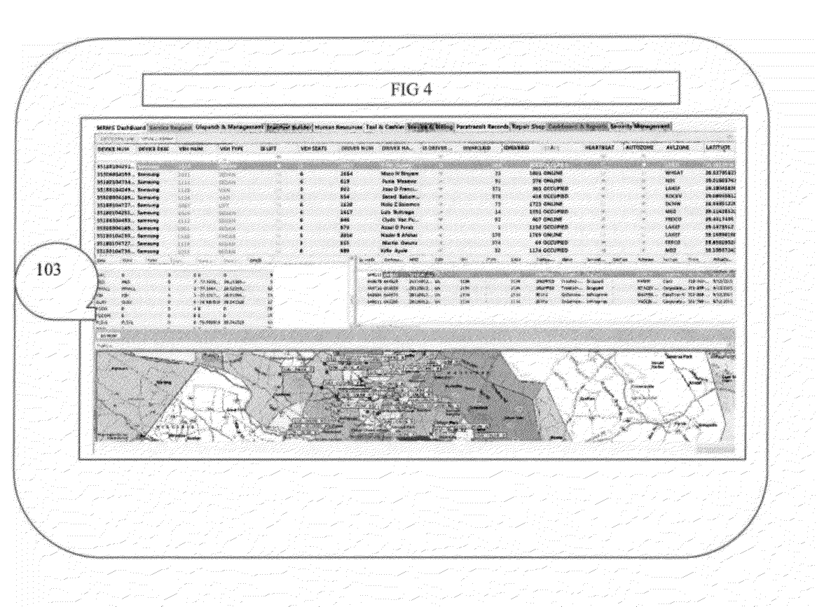

FIG. 5 is a screen shot of the automated dispatch system showing the proposed service requests for assignment in the next step, the list of members of a Trip Candidate Group (TCG) as well as the list of the full queue of requests to be processed in turn by each region.

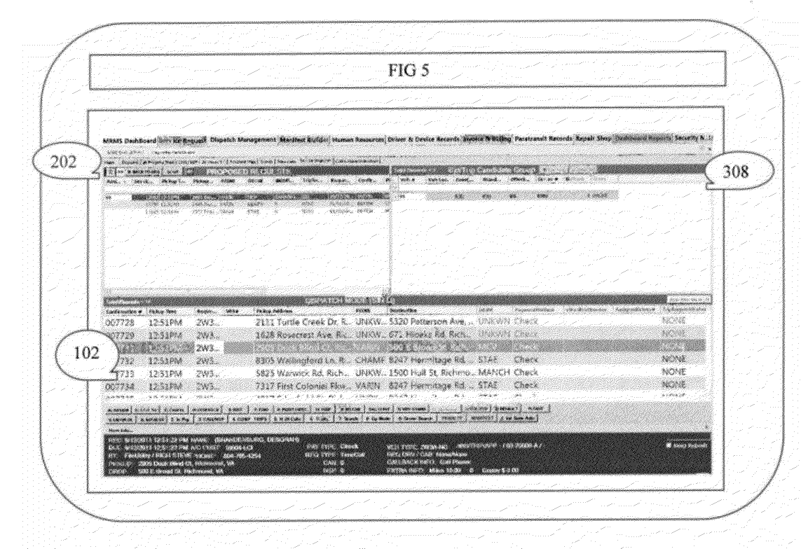

FIG. 6 is a screen shot of a smart device used by the mobile resource to communicate with the dispatch system showing the bidding process, zone stand screen, and the trip detail screen.

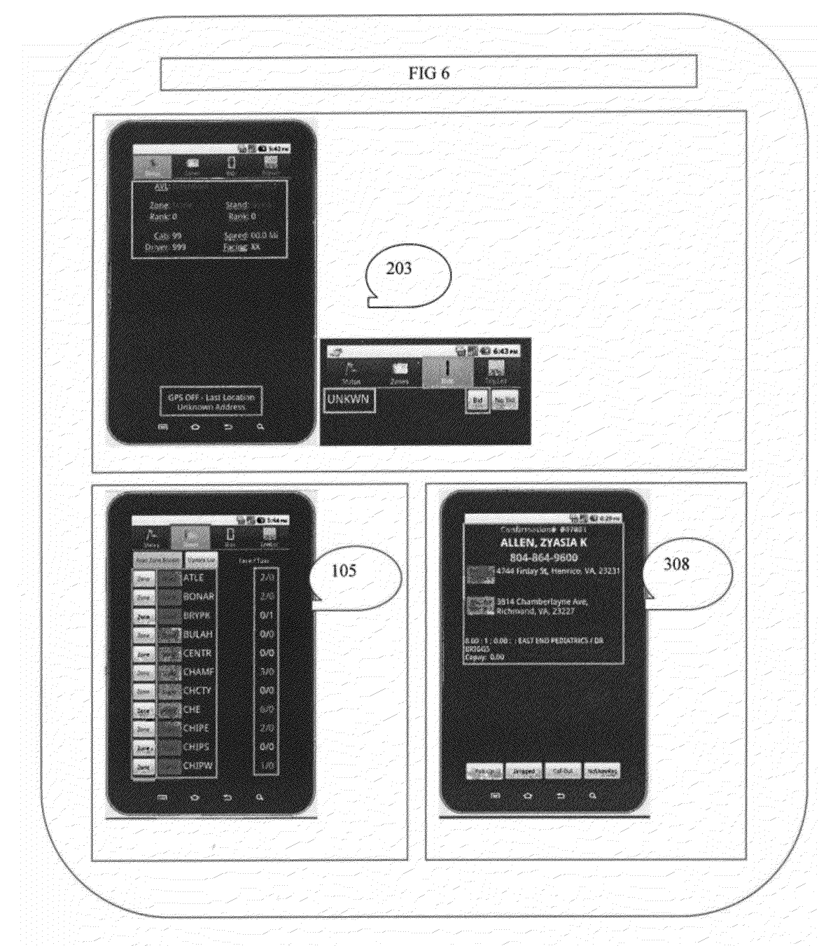

### DETAILED DESCRIPTION

In the detailed description that follows, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. This invention may be embodied in hardware, software, firmware, or any combination thereof.

This description generally relates to methods and apparatus for an automated real time dispatch system that applies a flexible best fit function to assign a queue of dynamic service request to a dynamic pool of mobile resources with provision for competitive bidding by mobile resources for the opportunity to provide service. The bidding process by which the mobile resources choose to bid does not violate the rules of independent contractors for mobile resources that are applicable to some of the businesses for which this invention can be used.

The dispatch process in the context of this invention is utilized most often when certain work forces or resources are outside of the office and a request for service is received at the office. Examples of such resources are police, field repair technicians, mobile medics, medical staff providing at home services, taxicabs, limousines and other forms of door-to-door or, more generally, point-to-point transportations.

Most dispatching today is handled by human dispatchers or some form of crude electronic dispatch. However, as mobile phones have converted to smart devices which are equipped with Global Positioning Systems (GPS) or other form of location identification and reporting and as the computing power at management offices has increased; intelligent automated dispatch is becoming a reality. The enhanced 911 rules require that every cell phone be equipped with in-door as well as out-door location identification. So that first responders, such as emergency medical technicians (EMTs), firemen and police, for example, can locate callers with relative pinpoint accuracy, including in multi-floor buildings and covered parking areas.

An important commercial application of location based reporting is reliable ubiquitous automated dispatch. Automated dispatch is the process of assigning requests to mobile resources based on a set of rules. Service requests in this context are taken for a fixed location and require the mobile resource to move to the location of service and provide the service for a certain duration. At the completion of service the mobile resource may be allocated to another request. An efficient assignment of resources requires that the automated dispatch system find the shortest distance between requests and mobile resources at the time of service. The goal is to minimize the cost function which depends on time and distance for travel to location of service. However, minimizing only the cost function is not sufficient. The system needs to consider many other aspects, such as equipment and mobile resource attributes and capabilities. Some service requests may have a higher priority based on a number of factors, such as a Service Level Agreement (SLA). There might be other attributes that an automated dispatch system may have to consider.

The present disclosure relates to methods and apparatus for an automated dispatch system. The main part of the system is the unit that processes all information including the locations, attributes and capabilities of mobile resource and the service requests and performs the Optimal Bidding and Dispatch Assignment (OBDA) 101. One embodiment of the system allows for offering the opportunity to bid on a real time basis to fulfill certain requested services. Service requests are entered into the system through various means such as a call center, a cell phone, or web access 102, for example. Service requests have a defined or computed geographical area (zone), a time of service, a Service Level Agreement (SLA) and other desired or mandatory service attributes (54).

The requested services are fulfilled by one of a plurality of mobile resources 103 that are made available and that desire to perform these services at the requested time. The mobile resources are equipped with smart devices that have a Global Positioning System (GPS) or other means of Automatic Mobile Resource Locator (AMRL) which is reported to the OBDA 101 at all times.

Mobile resource locations are mapped to zones. They may also announce their desired location for service to the OBDA which may be different from their actual location of service at the time of the service request. Mobile resources are also associated with certain attributes and capabilities 105. Attributes and capabilities of a mobile resource include the skill set of the mobile resource, for example in the case of medical personnel, attributes such as the ability to operate certain medical equipment, or in the case of transportation, it may include the size of the vehicle and its ability to accommodate wheelchair equipment. Sometimes attributes may include even the gender of the mobile resource, and smoking and not smoking. These attributes are essential to make the best match between request and mobile resource.

The OBDA keeps track of service requests and the pool of available mobile resources. The OBDA provides intelligent automated optimal matches between service requests and mobile resources on a real time basis with the following considerations.

The OBDA first selects a group of service requests that are within a certain area and within a window of time for service. The OBDA then forms a Bid Candidate Group (BCG) and provides this group with an opportunity to bid on a group of selected service requests. If the OBDA finds out that the proposed BCG is not large enough, it expands the search area and loosens the non-mandatory attributes restriction until the BCG has enough members to qualify as a BCG. The OBDA then provides a bid offer to all mobile resources that are in the BCG and waits for their response. Those Mobile resources that bid on the provided bid offer form a Trip Candidate Group (TCG). The OBDA then performs an optimal matching algorithm to find the best match between the selected list of requests and the TCG, which leads to one or more optimal assignments. The optimal assignments creates a numerical assignment grading system that considers one or more of the following for the best match and optimal assignments:

SLA of service requests;

Map based distance between the mobile resource and the service request;

The service request attributes vs. the mobile resource attributes;

The mobile resource desired zone as well as the mobile resource actual location;

Direction of traffic and effect of rush-hours on time and distance.

The OBDA then sends detailed information to the mobile resources in the TCG and requests explicit acceptance from the mobile resource to provide the requested service.

Mobile resources that reject the offer to provide the service may be penalized. If a mobile resource accepts a disadvantaged service request, which is in a remote location, is at a bad time of day or has other business disadvantages, the OBDA may reward the mobile resource with some credits for future services.

The OBDA may divide the area into multiple regions and run parallel processes, one for each region, where the number of requests is high and speed in dispatching is required. When multiple regions are dispatching in parallel it is likely that a mobile resource will participate in more than one BCG and receive offers from multiple regions. A mobile resource may be allowed to bid on all or some of the multiple bid-offers that it receives, in which case it will be competing for multiple service requests. When a mobile resource is competing in multiple regions a race condition is created which is resolved by the first region that selects that mobile resource, momentarily locking all other regions and automatically removing the selected mobile resource from offers in other regions.

This disclosure describes an intelligent system that can calculate distance, time, and mandatory requirements, as well as desirable attributes, into the dispatch system. Another issue that most conventional systems suffer from is dispatch load. To maintain the service request priorities and the mobile resources turn to bid and accept a service, certain dispatching functions need to be performed serially. The series technique and speed limitations on human interaction with a device in bidding and accepting a service request limits the number of service requests that can be processed in a given period of time. This disclosure introduces a parallel non-conflicting technique that allows requests to be associated to a region. Multi-threaded dispatch takes places, thereby multiplying the speed of dispatch by the number of regions.

In one embodiment, the service area is divided into a number of regions or zones of service. The zones of service may be an arbitrary number of user defined geographical areas. The system will work with the entire area of service being defined as one zone. However, for most efficient operation and for the best fencing function that enables the system to issue an alarm to management if a driver is operating outside of expected zones, it is recommended that the service area be quantized into a number of zones or regions 201.

The system makes extensive use of mapping software to determine distances between two points both in terms of time and in term of distances. As a part of system setup the map is also divided by drawing a line around each zone and giving each zone a name or a number. While a service request is being verified and is provided to the mapping software for calculating distances, it is also associated with a zone. When a mobile resource reports its current location, the mapping software will determine its current zone.

Each region or zone of service may be processed by parallel processing on different computers, by different processors on the same computer, or they may be processed on the same processor during the time that another process is suspended while waiting for one or more mobile resources to respond to a service request bid or process to time out. This division of service area into “R” regions increases the speed or the capacity of the dispatch system by “R” times.

Each region's processor in turn selects a zone within that region with a number of requests in a time window 202 around the current time, and sends bid requests to devices associated with the mobile resources based on the qualification rules, which will be described later. In this context each mobile resource is associated with a smart device, such as smart phone or tablet 203.

Multiple regions may communicate with a mobile resources pool. The system does not define the qualification rules for mobile resources to be in the same region as the service request. Therefore, one mobile resource may receive multiple bid requests, one from each region 204. The mobile resource may use certain logic to reject some of the bid requests and bid on one or more bid requests. Bidding on multiple bid requests will allow the mobile resource to compete in each region independently based on the rules, priorities and attributes of that region 204.

Bidding on multiple independent regions simultaneously will lead to certain race conditions, which could lead to the selection of one mobile resource by multiple regions. The system eliminates this race condition by using a locking technique. The first region that qualifies a mobile resource for a bid momentarily locks the resource pool and removes the selected mobile resource from the bidding process in all other regions automatically, as shown at block 206.

At this point in the process there is one request associated with one mobile resource. The system will assign the trip to the selected mobile resource and provide the detailed service request with all its attributes to the device (e.g., smartphone or tablet) associated with the selected mobile resource 107. The system will then request acceptance of the service request and expect an explicit response for accepting or rejecting performance of the service 108 by the mobile resource. The system considers a no-response from the operator as a rejection and returns the service request to the un-served queue for further processing.

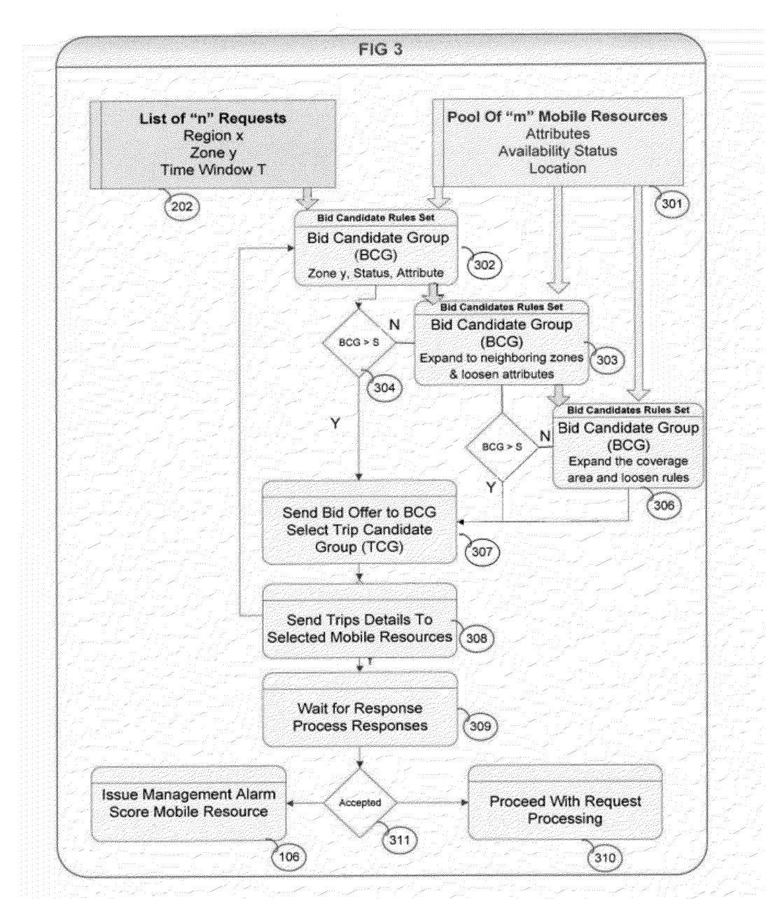

A detailed explanation of qualifying mobile resources to complete the service request is illustrated in FIG. 3 below.

The dispatch processor within a region x selects zone y for processing, which is within a window “T”. At that moment there are “n” tips to be processed (see FIG. 3, block 202). The processor has access to a table of all mobile resources logged into the system and which are active at that moment. This includes the current location, current zone, and desired zone of operation for all logged in mobile devices.

The processor will qualify all the logged in mobile resources based on Bid Candidate Rules (BCR) to produce a Bid Candidate Group (BCG) 302. The BCR may be different for different operations. In general, the BCR will qualify the resources based on matching mandatory attributes within a given zone and matching as many desirable attributes of the service request as possible. The system prefers to have more than one bidder for a service request. After applying the initial round of BCR, the processor checks at decision block 304 to see if there is the preferred minimum number of mobile resources available in the given zone. If there are not at least the preferred minimum members of a BCG in the given zone, the system will extend the BCR at block 303 to a larger search area and perform a looser attribute matching 303. The processor progressively checks again to see if it has achieved the goal of the preferred number of bidders in the BCG group. The system will continue to expand the search area until it achieves the preferred minimum number of members of the BCG or it has exhausted the rules of expanding the search criteria. This may require removing all desired matching attributes, extending the search to include all mobile resources and including the currently occupied mobile resources into BCG 306.

Once a BCG has been identified, the processor sends a bid request message at block 307 to all mobile resources within the BCG, and waits for a response. After a predetermined period of time the processor checks for positive bid responses. The mobile resources with positive bid responses form a Trip Candidate Group (TCG), which will be evaluated for best fit against the list of service requests.

The processor then implements a grading system between all service requests in the list against all mobile resources in the TCG, designated here as “g” this process will lead to an evaluation matrix dimensioned as g.n. In this Matrix each row represents a service request (SR) and each column represents a mobile resource selected in TCG as a candidate to provide the service. The system then evaluates each SR against each TCG member and creates a “Best-Fit-Function” grade. The assignment decision is then made based on the best fit grades. A group of SRs are assigned to a group of TCG members.

| | | List of Mobile Resource in the TCG | | | | | | | |
|---|---|---|---|---|---|---|---|---|---|
| | | TCG | TCG | TCG | TCG | | | | |
| n.g Matrix | | 1 | 2 | 3 | 4 | TCG 5 | . . . | . . . | TCG g |
| List Of | SR1 | 79 | 82 | 55 | 25 | 92 | | | 45 |
| Selected | SR 2 | 55 | 64 | 44 | 89 | 29 | | | 86 |
| Service | SR 3 | 97 | 12 | 66 | 79 | 45 | | | 77 |
| Request | . . . | | | | | | | | |
| SRs | SR n | | | | | | | | |

The processor selects the best fit functions to assign as many trips to as many mobile resources as may be feasible. It then sends the details of each service request to an associated selected mobile resource at block 308. This process of multiple mobile resources being evaluated against multiple service requests leading to potentially multiple best fit assignments allows for better selection of assignment of mobile resources to service requests because the system can perform a trade off analysis among the group of mobile resources in the TCG being evaluated.

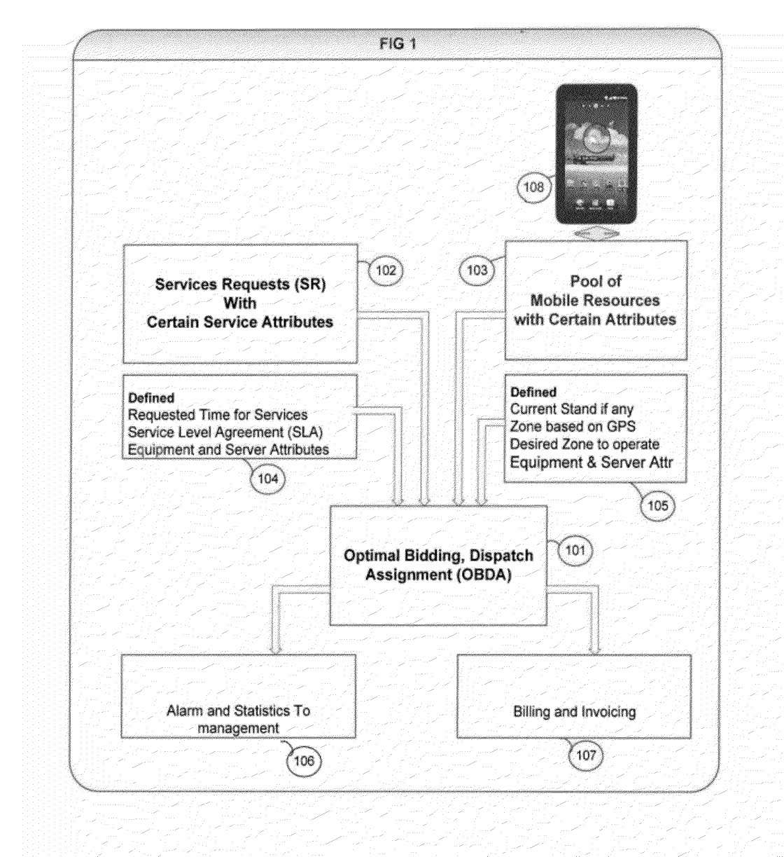

After sending the trip details to the selected mobile resource at block 309, the system waits for acceptance of the service request by the selected mobile resource. Should that selected mobile resource fail to respond or should it reject the service request for which it explicitly bid, the system may issue an alarm against that mobile resource for management intervention (see FIG. 1, block 106). The system provides for assessing certain penalties to reject a mobile resource from future bids (see FIG. 1, block 106) or make it harder for that mobile resource to accept future bids. On the other hand positive acknowledgement by the selected mobile resource and acceptance of the service request will cause the system to proceed on its normal request processing path at block 310. This path includes registering the trip (e.g., latitude, longitude, and time) for start of service, end of service, assessment of charges for service, and maintenance of the service records for later billing processes 107.

### CONCLUSION

It is to be appreciated that the Detailed Description section, and not the Summary and Abstract sections, is intended to be used to interpret the claims. The Summary and Abstract sections may set forth one or more but not all exemplary embodiments as contemplated by the inventor(s), and thus, are not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments, but should be defined only in accordance with the following claims and their equivalents.

What is claimed is:

1. A system for automated operation of a vehicle fleet, comprising:
means for automatically receiving a request to dispatch a vehicle to a particular location;
means for automatically determining the location of a vehicle to be dispatched; and
means for automatically sending instructions to that vehicle to proceed to the particular location.

2. A method for automated operation of a vehicle fleet, comprising:
automatically receiving a request to dispatch a mobile resource to a particular location;
automatically determining the location of a mobile resource to be dispatched; and
automatically sending instructions to that mobile resource to proceed to the particular location.

3. The method of claim 2, further comprising:
establishing a service area for the particular location;
automatically determining the location of a plurality of mobile resources within the established area;
electronically transmitting a request to the plurality of mobile resources to accept a request to proceed to the particular location;
electronically receiving acceptances from at least some of the plurality of mobile resources;
automatically selecting one mobile resource from among the mobile resources from which acceptances were received; and
automatically transmitting a notification of the selection of the service request to the selected mobile resource.

4. The method of claim 3, further comprising:
automatically establishing a plurality of service regions within the service area, each service region incorporating a plurality of service zones;
automatically determining the location of one or more mobile resources within a given service zone; and
automatically determining the location of a plurality of mobile resources within a given service region if the number of mobile resources within the given service zone does not meet a required minimum number.

5. The method of claim 4, further comprising:
automatically determining the location of a plurality of mobile resources within a given plurality of service regions within the service area if the number of mobile resources within the given service region does not meet a required minimum number.

6. The method of claim 5, further comprising:
automatically locating a plurality of mobile resources as a function of predefined attributes required for a mobile resource.

7. The method of claim 6, wherein the predefined attributes include:
whether a mobile resource is currently busy;
whether a mobile resource is currently not in service;
the distance of a mobile resource from a given service start location;
governmental regulations governing a given service request; and
any Service Level Agreement that is in effect with respect to a given request.

8. The method of claim 6, further comprising:
electronically receiving confirmation of acceptance of the selection from the selected mobile resource; and
automatically marking the corresponding service request as an in progress service request.

9. The method of claim 8, wherein:
if the selected mobile resource fails to confirm acceptance of the selection, then automatically removing that mobile resource from the TCG;
automatically selecting a second mobile resource from among the members of the TCG to proceed to the service start location; and
automatically transmitting a notification of the selection to the second mobile resource.

10. The method of claim 9, further comprising:
automatically receiving real-time traffic information to determine travel time between a member of a TCG and a given service start location to further determine whether to select that member to proceed to the given service start location.

11. The method of claim 9, further comprising, at substantially the same time, receiving a plurality of service requests and:
electronically transmitting requests to the plurality of BCGs to accept at least one of the requests to proceed to a service start location;
electronically receiving acceptances from a plurality of members of each BCG to define a plurality of TCGs;
automatically selecting one mobile resource from among the members of each TCG to proceed to a given service start location; and
automatically transmitting a notification of the selection to each selected mobile resource.

12. A method for automated operation of a mobile resource fleet upon receipt of a service request to dispatch a mobile resource, comprising:
establishing a region that includes a particular service request start location and a Bid Candidate Group (BCG), comprising a plurality of mobile resources that are available to be dispatched to the service start location;
electronically transmitting requests to the BCG to accept the service request to proceed to the service start location;
electronically receiving acceptances from a plurality of members of the BCG to define a Trip Candidate Group (TCG);
automatically selecting one mobile resource from among the members of the TCG to proceed to the plurality of service start locations within that region; and
automatically transmitting a notification of the selection of a particular trip to the selected mobile resource.

13. A method of selecting a plurality of service requests that are within a given time window and are within a selected service zone and to dispatch a mobile resource to each of some of the plurality of service requests, comprising:
establishing a Bid Candidate Group (BCG) comprising the plurality of mobile resources that are available for dispatch to a selected service zone;
electronically transmitting requests to the BCG to accept a service request to proceed to a service start location within the selected service zone;
electronically receiving acceptances from a plurality of members of the BCG to define a Trip Candidate Group (TCG);
automatically selecting a number of mobile resources from within the TCG to provide service in response to a corresponding service request from within the plurality of service requests; and
electronically transmitting a notification of a selected service request to a corresponding selected mobile resource.

14. An article of manufacture including a non-volatile computer readable medium having computer program logic stored thereon that, when executed by a computing device, cause the computing device to perform a method for automated operation of a mobile resource fleet upon receipt of a service request to dispatch a mobile resource, comprising:
establishing a region that includes a service start location and a Bid Candidate Group (BCG), comprising a plurality of mobile resources that are available to be dispatched to the service start location;
electronically transmitting a request to the BCG to accept the request to proceed to the service start location;
electronically receiving acceptances from a plurality of members of the BCG to define a Trip Candidate Group (TCG);
automatically selecting one mobile resource from among the members of the TCG to proceed to the service start location; and
automatically transmitting a notification of the selection to the one mobile resource.

15. The article of manufacture according to claim 14, wherein the computer program logic, when executed by the computing device, cause the computing device to perform the following additional operations, including:
electronically receiving confirmation of acceptance of the selection from the one mobile resource.

16. The article of manufacture according to claim 15, wherein the computer program logic, when executed by the computing device, cause the computing device to perform the following additional operations, including:
if the one mobile resource fails to confirm acceptance of the selection, then automatically removing that one mobile resource from the TCG;
automatically selecting a second mobile resource from among the members of the TCG to proceed to the service start location; and
automatically transmitting a notification of the selection to the second mobile resource.

17. The article of manufacture according to claim 16, wherein the computer program logic, when executed by the computing device, cause the computing device to perform the following additional operations, including:
automatically establishing a plurality of service regions within the service area, each service region incorporating a plurality of service zones;
automatically determining the location of one or more mobile resources within a given service zone; and
automatically determining the location of a plurality of mobile resources within a given service region if the number of mobile resources within the given service zone does not meet a required minimum number.

18. The article of manufacture according to claim 16, wherein the computer program logic, when executed by the computing device, cause the computing device to perform the following additional operations, including:
establishing a plurality of regions, each of which includes at least one service start location and at least one BCG;
electronically transmitting requests to the plurality of BCGs to accept at least one of the requests to proceed to a service start location;
electronically receiving acceptances from a plurality of members of each BCG to define a plurality of TCGs;
automatically selecting one mobile resource from among the members of each TCG to proceed to a given service start location; and
automatically transmitting a notification of the selection to each selected mobile resource.

19. The article of manufacture according to claim 18, wherein the computer program logic, when executed by the computing device, cause the computing device to perform the following additional operations, including:
automatically determining the location of a plurality of mobile resources within a given plurality of service regions within the service area if the number of mobile resources within the given service region does not meet a required minimum number.

20. The article of manufacture according to claim 19, wherein the computer program logic, when executed by the computing device, cause the computing device to perform the following additional operations, including:
automatically locating a plurality of mobile resources as a function of predefined attributes required for a mobile resource.

21. The article of manufacture according to claim 20, wherein the computer program logic, when executed by the computing device, cause the computing device to perform the following additional operations, including:
selecting a member of a TCG as a function of at least one of the following criteria:
whether a mobile resource is currently busy;
whether a mobile resource is currently not in service;
the distance of a mobile resource from a given service start location;
governmental regulations governing a given service request; and
any Service Level Agreement that is in effect with respect to a given request.

22. The article of manufacture according to claim 21, wherein the computer program logic, when executed by the computing device, cause the computing device to perform the following additional operations, including:
automatically receiving real-time traffic information to determine travel time between a member of a TCG and a given service start location to further determine whether to select that member to proceed to the given service start location.

23. An article of manufacture including a non-volatile computer readable medium having computer program logic stored thereon that, when executed by a computing device, cause the computing device to perform a method for automated operation of a mobile resource fleet upon receipt of a service request to dispatch a mobile resource, comprising:
automatically receiving a request to dispatch a vehicle to a particular location;
automatically determining the location of a vehicle to be dispatched; and
automatically sending instructions to that vehicle to proceed to the particular location.

24. The article of manufacture according to claim 23, wherein the computer program logic, when executed by the computing device, cause the computing device to perform the following additional operations, including:
establishing a region that includes the particular location;
automatically determining the location of a plurality of mobile resources within the established region;
electronically transmitting a request to the plurality of mobile resources to accept a request to proceed to the particular location;
electronically receiving acceptances from at least some of the plurality of mobile resources;
automatically selecting one mobile resource from among the mobile resources for which acceptances were received; and
automatically transmitting a notification of the selection of the one mobile resource to that mobile resource.
